(19) United States
(12) Patent Application Publication
(10) Pub. No.: US 2008/0128666 A1
(43) Pub. Date: Jun. 5, 2008

(54) CHEMILUMINESCENT SYSTEM

(75) Inventor: Keith J. Allison, Blandon, PA (US)

Correspondence Address: RATNERPRESTIA, P O BOX 980, VALLEY FORGE, PA, 19482-0980, US

(73) Assignee: Crayola, LLC, Easton, PA (US)

(21) Appl. No.: 12/029,158

(22) Filed: Feb. 11, 2008

Related U.S. Application Data
(63) Continuation-in-part of application No. 11/302,020, filed on Dec. 13, 2005.

(51) Int. Cl. C09K 11/08

(52) U.S. Cl. 252/700

(57) ABSTRACT

A chemiluminescent reactant solution and a layer containing a solid oxidizer. An embodiment of the invention has the layer containing a solid oxidizer supported by a substrate such as paper. The reactant solution includes an oxalate and a fluorescer and reacts with the oxidizer after it is applied to the oxidizer layer. A preferred embodiment of the invention includes the presence of an oxidizer activator layer. A chemiluminescent marking system including a chemiluminescent reactant solution in at least one first delivery applicator and an oxidizer solution in a second delivery applicator. The oxidizer solution reacts with the chemiluminescent reactant solution to cause the chemiluminescent reactant solution to glow. A stabilizer may also be included in the oxidizer solution.

### CROSS REFERENCE TO RELATED APPLICATIONS

This application is a continuation-in-part application of U.S. patent application Ser. No. 11/302,020, filed Dec. 13, 2005, which is incorporated herein by reference in its entirety.

### FIELD OF THE INVENTION

The present invention relates generally to chemiluminescence, and more particularly to chemiluminescent systems that allow a chemiluminescent solution to react on a substrate having a solid oxidizer or by contacting the chemiluminescent solution with an oxidizer solution.

### BACKGROUND OF THE INVENTION

The use of chemiluminescent, or oxyluminescent, reactions to produce light without the use of electricity, is known. These reactions involve chemical components which react chemically and provide excitation of a fluorescent compound. The generation of light in this manner has been found useful in situations where it is desirable to have a source of visible light that is not electrically activated. Such situations would include places where there is no source of electricity, or for places in which the presence of electricity would be hazardous, such as near flammable materials. Still other applications have been in novelty items and toys.

Generally, these reactions involve oxalates, fluorescing dyes, and oxidizers. One known chemistry involved in the production of visible light through chemiluminescent reactions is based on the reaction of a hydroperoxide and a chemiluminescent reactant comprised of an oxalate, such as an oxalic-type anhydride, an oxalic-type ester, or an oxalic-type amide, and a fluorescer. Many such systems are known.

### SUMMARY OF THE INVENTION

In one aspect, the present invention provides a chemiluminescent reactant solution and a layer containing a solid oxidizer. An embodiment of the invention has the layer containing a solid oxidizer supported by a substrate such as paper. The reactant solution includes an oxalate and a fluorescer and reacts with the oxidizer after it is applied to the oxidizer layer. A preferred embodiment of the invention includes the presence of an oxidizer activator layer. With such an embodiment, the solid oxidizer is first activated and then reacted with the chemiluminescent reactant solution to cause a glowing mark. The fluorescer in the chemiluminescent reactant solution defines the glowing color seen as a result of the reaction.

A preferred embodiment consistent with that described in the preceding paragraph includes a chemiluminescent system comprising a chemiluminescent reactant solution in a delivery applicator, and a substrate supporting a first layer comprising a solid oxidizer and a second layer comprising an oxidizer activator.

In another aspect, the present invention provides a chemiluminescent marking system comprising a chemiluminescent reactant solution in at least one delivery applicator and an oxidizer solution in a second delivery applicator. The oxidizer solution is reactive with the chemiluminescent reactant solution to cause the chemiluminescent reactant solution to glow.

In an embodiment according to this aspect, the present invention consistent with that described in the preceding paragraph provides a chemiluminescent marking system in which the oxidizer solution in the second delivery applicator comprises hydrogen peroxide, water and a stabilizer.

### DETAILED DESCRIPTION OF THE INVENTION

In one aspect, the present invention comprises a paper and an applicator (such as a marker or paint system) which combine in use to provide a glow-in-the dark marking after the applicator applies its contents to the surface of the paper. More specifically, the delivery applicator delivers a reactant solution to a treated paper surface to react with the contents of the treated surface in a chemiluminescent reaction to produce light in the region of the marking. A preferred embodiment of the invention includes a marker ink solution comprised of fluorescers and an oxalate in a suitable solvent. Although some fluoroescers have a natural, or “daylight” color, some do not, and so a preferred embodiment also includes a non-luminescing dye to impart a “daylight” color to the marking ink, which might otherwise appear colorless. Generally, the fluorescers are dyes that emit light energy, or “glow,” when “charged” via energy transfer from an excited intermediate ingredient. The oxalate is the energy provider that transfers its energy to the dye through the chemical reaction.

The paper substrate includes an oxygen-providing compound, or oxidizer, such as a bleach or stable peroxide, and an oxidizer activator. The oxygen-providing compound, which can also be deemed an oxygen-releasing compound, releases oxygen during reaction with the fluorescer and oxalate. The oxygen-providing compound can take many forms, and includes common chemical bleaches such as sodium hypochlorite, chlorine bleach, and oxygen bleach, which contains hydrogen peroxide. A preferred oxygen-providing compound is a peroxide, particularly a perborate, such as sodium perborate.

The invention involves delivering the oxalate and fluorescer to the treated substrate (which in one embodiment is paper) which has at least one layer containing the oxidizer. The oxalate and fluorescer are contained essentially in solution and are preferably delivered to the treated paper via a marker (although other delivery means could be used) wielded by a user. The marker nib contacts the treated paper surface and the oxalate and fluorescer react with the oxidizer in a chemiluminescent reaction to form a “glowing” mark which can be seen by the user even when no light is otherwise present. As noted, other delivery applicators could be used, including a paintbrush, or a pen.

In the preferred embodiment just described, the marker contains a solution of the oxalate and fluorescer as noted above, in addition to a solvent. A preferred solvent is a suitable oil-based solvent. In a preferred embodiment, the marker solution would also contain an additive which will give the solution a visible color when in the presence of external light so that the user can see what “color” the glowing mark will be. In such a case, the additive should provide indication of the same color as that which will be emitted upon reaction with the oxidizer, or as close a match as possible.

Such solutions (without the addition of a visible color indicator) are known, such as the system disclosed in U.S. Pat. No. 5,931,383, which is incorporated by reference herein. That patent discloses a yellow chemiluminescent system, with what it calls the “oxalate” component and the “activator” component. The oxalate component is disclosed as including dibutyl phthalate, bis(2,4,5-trichloro-6-carbopentoxyphenyl)oxalate as the oxalate, and 1-chloro-9,10-bis(phenylethynyl)anthracene as the fluorescer. In that patent, the activator component is the oxidizing composition and includes dimethyl phthalate, T-butyl alcohol, hydrogen peroxide, and sodium salicylate. That patent discloses simply mixing the two components to form a glowing yellow light. The two components are contained inside a device in which the two components are separated by a frangible vial that when ruptured causes the two components to mix.

In one aspect, the present invention, however, involves the application of the marker solution (plus preferably the visible light indicating dye as discussed above) on a substrate. The substrate provides the oxidizing component. When the solution is laid down on the substrate, the chemiluminescent reaction occurs as the oxalate and fluorescer in the marker solution react with the oxidizer on the substrate. It has been found, however, that the reaction is weak. The present invention solves that problem by providing an activator for the oxidizer in a layer on the treated substrate adjacent the oxidizer layer. When the marker solution contacts the treated substrate, the oil in the marker solution allows for the contacting of the oxalate, fluorescer, oxidizer, and oxidizer activator to produce a more vigorous reaction (as compared to the same reactant system without the activator) and the “glowing” mark appears. Moreover, the oxidizer is activated and the reaction with the oxalate occurs, creating a high-energy intermediate that transfers its energy to the fluorescers, causing them to emit visible light of a color defined by the particular fluorescer.

The oxidizer activator can be disposed in a layer on the treated substrate either above or below (or both) the oxidizer layer. It is important that the activator not be mixed with the oxidizer for long periods of time before the reaction occurs or the activation of the oxidizer will occur prematurely. Thus, by disposing each in a different layer, they only mix after the “ink” (which comprises the oxalate and fluorescer) is applied by the marker (or paint or other applicator). At that time, the reactants all mix, including the activator, and the chemiluminescent reaction occurs to provide the glowing mark.

A preferred oxidizer activator for use in the present invention is tetra acetyl ethylene diamine (TAED). TAED works to activate the bleaching reaction at ambient temperatures (like room temperature), and also acts to enable bleaching under milder pH conditions to produce a stronger oxidant than without the activator. The activator allows for oxidation to occur with an oxidizer that is otherwise stable until activated. For example, perborates are oxygen-releasing materials that only have effective bleaching activity at relatively high temperatures (compared to room temperature), for example 60° C. in an aqueous system. In contrast, other oxygen sources like percarbonate readily liberate oxygen in water, but such sources are not suitable for this aspect of the present invention because they are not stable in air, water, or at higher temperatures. It is the combination of activator and oxidizer which works in this aspect of the present invention to insure proper and controlled timing of the oxidizing reaction.

Many bleach activators include carboxylic acid esters or amides. Typically, in an aqueous system, anions of hydrogen peroxide react with the ester or amide to generate a corresponding peroxyacid. A preferred activator enhances the reaction by reacting with perborate to release hydrogen peroxide. In addition to TAED, nonanoyloxybenzene sulfonate (NOBS) will work in the present invention.

Preferred oxalate and fluorescer solutions are available from Omniglow Corp., and are available in many colors. These mixtures are known to Omniglow Corp. and are available from Omniglow Corp. As noted above, in some cases, these oxalate and fluorescer solutions are combined with a visible color additive, such as a dye, to give the “ink” a color in daylight.

The invention includes a substrate coated with at least a peroxide layer. In such an embodiment, the applicator sets down the oxalate/fluorescer solution which reacts with the peroxide layer to form a glowing mark on the substrate. As noted above, however, where a stronger and/or longer-lasting reaction is desired, it may be necessary to include a second layer, in addition to the peroxide layer, which second layer includes an oxidizer activator.

Thus a preferred embodiment includes a substrate of paper, as noted above, to which is applied at least two layers. One layer contains the oxidizer, and the other layer contains the oxidizer activator. In such an embodiment, the first layer would comprise an organic peroxide which could be laid down in an aqueous solution containing a binder resin (so it adheres, or “sticks” to the paper—one example is polyvinyl pyrollidone). The top layer could then be laid down after the first layer dries and would contain the activator.

In some instances, depending in part on the material comprising the substrate, as well as the printing process used, multiple layers of the same composition may be laid down, with each one being allowed to dry before application of the next. This is because typical printing processes deliver many tiny dots of the coating on the paper. This creates a hill-and-valley topography. Printing a single thicker layer only increases the size of the hills, creating an uneven coating across the paper. By applying multiple layers, such as two, (one overtop the other), and because the dots seldom fall in the exact same spot as they did with the first coat (natural offset), a smoother application of the layers, with a more even distribution of dots, occurs across the substrate.

Still another preferred embodiment comprises treating a paper substrate with three layers total, with the first two coats having the oxidizer layer followed by a coat of the activator layer. In this preferred embodiment, the first two layers applied to the paper comprise organic peroxide, which, as above, is laid down in an aqueous solution. The second oxidizer layer is laid down after the first oxidizer layer is dry. This double-layering in effect allows for an increased presence of the perborate. The third and outer layer is then applied, after the second layer dries, and contains an activator such as TAED. The following TABLE I illustrates the amounts of each ingredient in this preferred embodiment. In this example, each layer was applied individually and allowed to dry between each coating step.

TABLE I

| | |
|---|---|
| Layers 1 and 2 - | 70.8 wt % water |
| Oxidizer layers, | 15 wt % sodium perborate |
| laid down | 12 wt % % polyvinyl pyrollidone as binder |
| separately | resin [ISP] |
| | 2 wt % dispersant [Surfynol CT-171 from |
| | Air Products & Chemiclas, Inc.] |
| | 0.2 wt % biocide [Acticide GA from Acti- |
| | Chem] |
| Layer 3 - | 62.3 wt % water |
| Activator | 10.5 wt % polyvinyl pyrollidone as binder |
| | resin [ISP] |
| | 25 wt % TAED |
| | 2 wt % dispersant [Surfynol CT-171 from |
| | Air Products & Chemiclas, Inc.] |
| | 0.2 wt % biocide [Acticide GA from Acti- |
| | Chem] |

Still yet another embodiment includes a system having five layers disposed on a substrate of paper. In this preferred embodiment, a first layer applied to the paper comprises an activator, which is laid down in an aqueous solution containing polyvinyl pyrollidone and TAED. Second and third layers are then applied, each containing an organic peroxide, such as sodium perborate. The fourth layer is then applied which is comprised of the activator again. The top layer, or coating layer, is a barrier overcoat, and crosslinks with the perborate layer. It preferably comprises a polyvinyl acetate. In this embodiment, the presence of the coating layer prolongs the flowing effect as compared to the same system without the coating layer. This is due to the fact that a typical capillary marker will deliver a thin film that reacts relatively quickly to produce a bright glowing mark. To slow the reaction, which may in come cases be preferred, the coating layer is provided which slows the ink penetration through the layers and extends the overall glowing effect over time. The following Table II illustrates the amounts of each ingredient in this preferred embodiment. In this preferred embodiment, each layer is coated individually and allowed to dry between each coating.

TABLE II

| | |
|---|---|
| Layer 1 - | 49.8 wt % water |
| Activator | 3 wt % polyvinyl pyrollidone as binder resin [ISP] |
| | 15 wt % TAED |
| | 30 wt % filler [Permont SC-20, which is a 20% clay |
| | dispersion in water, offered through Southern Clay |
| | Products] |
| | 2 wt % dispersant [Surfynol CT-171 from Air Products |
| | & Chemiclas, Inc.] |
| | 0.2 wt % biocide [Acticide GA from Acti-Chem] |
| Layers 2 and 3 - | 70.8 wt % water |
| Oxidizer layers, | 15 wt % sodium perborate |
| laid down | 12 wt % % polyvinyl pyrollidone as binder resin [ISP] |
| separately | 2 wt % dispersant [Surfynol CT-171 from Air Products |
| | & Chemiclas, Inc.] |
| | 0.2 wt % biocide [Acticide GA from Acti-Chem] |
| Layer 4 - | 62.3 wt % water |
| Activator | 10.5 wt % polyvinyl pyrollidone as binder resin [ISP] |
| | 25 wt % TAED |
| | 2 wt % dispersant [Surfynol CT-171 from Air Products |
| | & Chemiclas, Inc.] |
| | 0.2 wt % biocide [Acticide GA from Acti-Chem] |
| Layer 5 - | 64.8 wt % water |
| Barrier | 0.2 wt % biocide [Acticide GA from Acti-Chem] |
| | 35 wt % PVA solution [Celvol 23-204 from Celanese] |

The above examples are illustrative of two particular embodiments of the present invention. In each case, each oxidizer layer could comprise 3-93 wt % water (before it is dry), 1-95 wt % perborate, 5-15 wt % binder resin, optionally up to 2 wt % dispersant, and optionally a biocide up to 1 wt %. The activator layer(s) can comprise 3-94.5 wt % water, 5-65 wt % binder resin, 0.5-95 wt % activator (preferably TAED), optionally up to 2 wt % dispersant, and optionally a biocide up to 1 wt %. In an embodiment using the barrier layer, that layer should be laid down while comprising 10-95 wt % water, 5-90 wt % polyvinyl alcohol, and optionally up to 3 wt % biocide.

Of course, substrates other than paper could be used with the present invention, so long as suitable adhesion is achievable between the substrate and the first layer of the treatment. Examples of other substrates could be the surface of a three-dimensional object, such as a model, figurine or toy.

It is also noted that the exact order of layers is not necessarily critical to the performance of the invention. It could be envisioned that a single peroxide layer is applied. Where relatively intense development of chemiluminescence is desired, however, at least one activator layer should be disposed above the oxidizer layer(s) so the activator is picked up by the laid-down mark (and therefore the oxalate/fluorescer solution) before it gets to the oxidizer layer where the reaction then occurs.

In another embodiment of the invention, the substrate containing the oxidizer could be the paper itself if perborate (such as sodium perborate) is used in the making of the paper and thus embedded therein. In such a case, the perborate-containing paper would be coated with the activator layer and the perborate-containing paper would have to be porous enough to allow contact between the perborate and other reactants at the time of the application of the mark.

In another aspect, the present invention provides a chemiluminescent marking system. More specifically, a preferred embodiment of the chemiluminescent marking system according to this aspect comprises the chemiluminescent reactant solution in at least one first delivery applicator and an oxidizer solution in a second delivery applicator. When the activator solution is brought into contact with the chemiluminescent reaction solution, the chemiluminescent reactant glows.

In an embodiment according to this aspect, the delivery applicator includes a chemiluminescent reactant solution, as described previously, in a first delivery applicator. Preferably, the first and the second delivery applicators are markers, in which the chemiluminescent solution and the oxidizer solution each comprise a marker “ink” solution in the respective marker. When the user draws or writes a mark on a substrate, for example paper, with the marker including the chemiluminescent reactant solution, the chemiluminescent reactant solution is applied to the substrate via the marker nib. As described previously, the chemiluminescent reactant solution may optionally include an additive which will give the solution a visible color when in the presence of external light so that the user can see what “color” the glowing mark will be. The additive colorant may be transferable from the solution to the substrate similar to that of a conventional marker.

Subsequent to laying down the chemiluminescent solution on the substrate, the user draws or writes over the chemiluminescent mark with the second marking instrument, which includes the oxidizer solution. Upon contact with the oxidizer solution, the chemiluminescent solution is activated and the mark glows for a predetermined period of time.

The system may further include multiple delivery applicators containing chemiluminescent reactant solutions, each having a different color. When the marking instrument containing the oxidizer solution is brought into contact with the different chemiluminescent solutions laid down on the substrate, the chemiluminescent reactant solutions are activated and glow with their respective colors.

The delivery applicators, or marking instruments, that may be used in the present invention can include paintbrushes, pens, markers, rollers, stamp pads, or the like.

According to this aspect, the oxidizer solution that activates the chemiluminescent reactant solution comprises an oxygen-providing compound. Suitable oxidizer solutions include peroxide solutions, such as hydrogen peroxide, perborate, percarbonate, or carbamide peroxide. Further, those solid oxidizers of the type applied to the treated substrate of the embodiments of the invention described previously may also be used to prepare the oxidizer solution. For example, an aqueous sodium perborate solution or an aqueous sodium percarbonate solution may be used. It is also contemplated that other peroxide liberating solutions may also be utilized in the present invention. Preferably, the oxidizer solution is a water-based solution and includes about 0.5% to about 35% by weight hydrogen peroxide and a balance of water. More preferably, the oxidizer solution includes about 20% by weight hydrogen peroxide and the balance of water. Above about 35%, the hydrogen peroxide causes skin irritation. As a minimum, below about 0.5% the hydrogen peroxide becomes less effective to apply to the oxalate oils to produce a visible glow (viewed in the dark) for at least a half-hour. It is intended that for art applications, such as those intended for use by children, a glow of several hours is desirable.

One factor in determining the oxidizer solution concentration is the color of the chemiluminescent reactant with which the oxidizer solution will be reacted. For example, a yellow chemiluminescent solution glows brightest and longest, while a red chemiluminescent solution generally glows the shortest when contacted with the same amount of oxidizer solution. Thus, for a system in which multiple chemiluminescent markers containing red, yellow and other possible colors are provided, if the concentration of the oxidizer solution is formulated for a glow time of 4 hours for the red chemiluminescent solution, the other colors would be expected to glow longer than 4 hours.

In this aspect, the invention provides a marking system in which a user is able to write with the marking instrument or a plurality of marking instruments containing the chemiluminescent marking solution. The marking instrument contains a colored chemiluminescent solution that is first applied to the substrate. Once the chemiluminescent has been applied to the substrate, the user can next apply the activator solution to the chemiluminescent solution on the substrate. Once the activator solution contacts the chemiluminescent solution on the substrate, the chemiluminescent solution glows for a predetermined period of time.

In an alternative embodiment according to this aspect, the user first draws or writes a mark on a substrate, for example paper, with the marking instrument including the oxidizer solution to produce a clear, or colorless, mark. Subsequent to laying down the oxidizer solution on the substrate, the user draws or writes over the oxizer solution mark with a second marking instrument (or instruments), which includes the chemiluminescent solution. Upon contact with the oxidizer solution, the chemiluminescent solution is activated and the mark glows for a predetermined period of time. In other words the clear, or colorless, mark is “revealed” in the dark as the respective color(s) of the chemiluminescent solution(s) that contact the oxidizer mark.

Optionally, the present invention further provides that the oxidizer solution includes additives such as stabilizers. A stabilizer is added to help to retard peroxide's natural tendency to break down in water (due to heat, light, etc) and produce water and carbon dioxide. Preferably, the stabilizer, if included, is present in an amount up to about 10% by weight. More preferably, the stabilizer, if included, is present in an amount of about 2% to about 4% by weight. A stabilizer is particularly helpful in oxidizer solutions of hydrogen peroxide. One example of an additive to the oxidizer solution is a proprietary blend of a stabilizer solution known as Oxystab C, available from Manufacturer's Chemicals, a division of Synalloy Corp.

Other suitable stabilizers that aid in reducing the rate of decomposition of the peroxide include aromatic chelating agents and phosphonic acid chelating agents. One example of phosphonic chelating agents suitable in the present invention include those sold under the name DEQUEST® by Solutia, Inc. These stabilizers may be present in an amount of up to about 1%.

A further component that may optionally be included in the oxidizer solution are pH regulators, such as mild acids, which help to keep the pH low, preferably below 6.5, and to help slow the decomposition of the peroxide.

Although preservatives may optionally be added to the oxidizer solution as additives, such preservatives are not necessary in the oxidizer solution due to the inherent antimicrobial properties of the peroxide of the oxidizer solution.

An alternative to a water-based or aqueous oxidizer solution, the oxidizer solution may be organic-solvent based. For example, another embodiment of the invention includes an oxidizer solution comprising carbamide peroxide and propylene glycol or glycerin. Preferably, in such an embodiment, the carbamide peroxide is present in an amount of about 6% to about 10% by weight, with the balance being glycerin or, alternatively, propylene glycol. More preferably, the carbamide peroxide is present in an amount of about 8% by weight carbamide peroxide and the balance of propylene glycol or glycerin.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A chemiluminescent marking system comprising:
a chemiluminescent reactant solution in at least one first delivery applicator; and
an oxidizer solution in a second delivery applicator;
said oxidizer solution reactive with said chemiluminescent reactant solution to cause said chemiluminescent reactant solution to glow.

2. The system of claim 1 wherein said chemiluminescent reactant solution comprises an oxalate and a fluorescer.

3. The system of claim 1 wherein said oxidizer solution comprises a peroxide solution.

4. The system of claim 1 wherein said peroxide solution comprises hydrogen peroxide, perborate, percarbonate, or carbamide peroxide.

5. The system of claim 1 wherein said oxidizer solution comprises:
about 0.5% to about 35% by weight hydrogen peroxide; and
a balance of water.

6. The system of claim 5 wherein said oxidizer solution comprises:
about 20% by weight hydrogen peroxide; and
the balance of water.

7. The system of claim 1 wherein said oxidizer solution further comprises a stabilizer.

8. The system of claim 7 wherein said stabilizer is present in an amount up to about 10% by weight.

9. The system of claim 8 wherein said stabilizer is present in an amount of about 2% to about 4% by weight.

10. The system of claim 1 wherein said oxidizer solution further comprises an acid.

11. The system of claim 1 wherein said oxidizer solution comprises:
about 6% to about 10% by weight carbamide peroxide; and
a balance of propylene glycol or glycerin.

12. The system of claim 11 wherein said oxidizer solution comprises:
about 8% by weight carbamide peroxide; and
a balance of propylene glycol or glycerin.

13. The system of claim 1 wherein said oxidizer solution comprises an organic peroxide in an aqueous solution.

14. The system of claim 1 wherein said at least one first marking instrument comprises a plurality of first delivery applicators.

15. The system of claim 1 wherein said first delivery applicator comprises a paintbrush, a pen, a marker, a roller or a stamp pad.

16. The system of claim 1 wherein said second delivery applicator comprises a paintbrush, a pen, a marker, a roller or a stamp pad.

17. The system of claim 1 wherein said chemiluminescent reactant solution further comprises a visible color generating additive.

18. A chemiluminescent marking system comprising:
a chemiluminescent reactant solution in at least one first delivery applicator; and
an oxidizer solution in a second delivery applicator, said oxidizer solution comprising:
hydrogen peroxide; and
water;
said oxidizer solution reactive with said chemiluminescent reactant solution to cause said chemiluminescent reactant solution to glow.

19. The system of claim 18 wherein said oxidizer solution comprises:
about 0.5% to about 35% by weight hydrogen peroxide; and
a balance of water.

20. The system of claim 18 wherein said oxidizer solution further comprises a stabilizer.

21. The system of claim 20 wherein said stabilizer is present in an amount up to about 10% by weight.

22. The system of claim 18 wherein said chemiluminescent reactant solution comprises an oxalate and a fluorescer.
